(19) United States
(12) Patent Application Publication
(10) Pub. No.: US 2010/0191516 A1
(43) Pub. Date: Jul. 29, 2010

(54) Well Performance Modeling In A Collaborative Well Planning Environment

(76) Inventors: Timothy G. Benish, Pearland, TX (US); Scott R. Clingman, Houston, TX (US); Bruce A. Dale, Sugar Land, TX (US); James E. Holl, Houston, TX (US); Rune Musum, Stavanger (NO)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/663,819

(22) PCT Filed: Jul. 22, 2008
(86) PCT No.: PCT/US2008/070778

§ 371 Date: Dec. 9, 2009

Related U.S. Application Data
(60) Provisional application No. 60/967,804, filed on Sep. 7, 2007.

(51) Int. Cl. G06G 7/48

(52) U.S. Cl. 703/10

(57) ABSTRACT

Methods and systems are provided that may be utilized to make completion design an integral part of the well planning process by enabling the rapid evaluation of completion performance. This integration may include an earth model and may specify wellpath parameters, completion parameters, and other parameters in a simulation of operations using the earth model. The simulation generates well performance measures, which may be optimized depending on well performance technical limits. The optimization may be used to maximize an objective function. The system may include multiple users at the same or different locations (e.g. over a network) interacting through graphic user interfaces (GUI's).

### CROSS REFERENCE TO RELATED APPLICATIONS

This application is the National Stage entry under 35 U.S.C. 371 of PCT/US2008/070778, that published as WO 2009/032416 and was filed 22 Jul. 2008, which claims the benefit of U.S. Provisional Application No. 60/967,804, filed 7 Sep. 2007, each of which is incorporated herein by reference, in its entirety, for all purposes.

### BACKGROUND

The present invention generally relates to methods for maximizing the efficiency of locating and extracting petroleum from a subsurface location. More specifically, the present invention relates to providing a collaborative three-dimensional well planning environment.

### DESCRIPTION OF THE RELATED ART

A reservoir may include one or more subsurface rock formations. These subsurface rock formations are porous and permeable and may contain liquid and gaseous hydrocarbons. The degree of porosity relates to the volume of fluid contained within the reservoir. The permeability relates to the ability of the fluid to move through the rock within the reservoir.

Decisions regarding reservoirs, such as those relating to well placement and well trajectory details, may be made by reservoir management teams. Reservoir management teams may include engineers, geoscientists, and other personnel associated with the project. Because of the cost and economic risk associated with drilling a new well, proper well placement significantly impacts the cost of producing the hydrocarbons as well as the maximum production rates and ultimate recovery of the hydrocarbons. The current well planning process typically involves collaboration between several members of a reservoir management team. The well planning process may also involve the evaluation and analysis of multiple well sites.

The well placement process typically begins with selection of well placements or locations. This process typically involves an inspection of geologic data. For example, a reservoir management team may consider the physical shape and properties of subsurface formations. They may also consider existing wells and general surface topography when selecting candidate locations. One or more possible well locations may be chosen and a reservoir simulation may be performed to predict the productivity of each well in the field. This process may be repeated for each location of possible interest, often at great expense. Many of the simulations that are performed at this stage analyze only wellpaths with particular deviation angles through the reservoir. That is, these simulations neglect a myriad of other possible wellpath trajectories.

Once the number of well locations (e.g. possible well sites or well placements) is limited by review, well path planning may be performed. As an example, the reservoir simulation model 3D grid and its properties may be transferred to wellpath planning software, as is known in the art. As an example, one method for estimating the effect of the wellpath location on well productivity by predicting the reservoir “quality” for each potential wellpath is described in U.S. Pat. No. 6,549,879. Once an optimized wellpath is defined for each of the wells in the predefined limited subset, the completion design for the wells may then be analyzed.

Typically, once the well placement is determined, completion designs are considered for the specific wells. These design considerations may include drilling- or completion-induced productivity impairment, hydraulic effects, sand control requirements, well clean-up, stimulation, downhole flow control or management of production rates to avoid well damage. However, because the effects of well placement on completion design are not considered in the typical well planning process, the completion design may be sub-optimal. That is, the completion design may be unduly restricted to conform to limits imposed by the initial well location.

Consequently, the well planning process may be enhanced using a collaborative environment that provides the ability to optimize completion design while allowing modification of well placement and well trajectories.

Other related information may be found in U.S. Pat. No. 6,801,197; U.S. Pat. No. 7,003,439; U.S. Pat. No. 7,096,172; U.S. Pat. No. 7,181,380; U.S. Patent Application Pub. No. 2005/0211468; and U.S. Patent Application Pub. No. 2006/0247903.

### SUMMARY

Embodiments of the present invention generally provide methods and apparatus for modeling well performance in a collaborative three-dimensional well planning environment.

One embodiment provides a method for well planning incorporating well completion design in a collaborative environment. The method generally includes specifying one or more wellpath parameters defining a wellpath to a target (or set of targets) within an earth model stored in memory, specifying one or more operating parameters defining a completion operation, simulating the completion operations using the earth model based on the wellpath parameters and the completion parameters to generate a set of well performance measures, and determining whether the well performance measures are within defined well performance technical limits. If the well performance measures are within the defined well performance technical limits, optimizing well placement within the earth model stored in memory in order to maximize an objective function and if the well performance parameters are not within the defined well performance technical limits, adjusting one or more of the wellpath parameters, the completion parameters, and any combination thereof to generate adjusted parameters and repeating the simulating operations utilizing the adjusted parameters.

One embodiment provides a computer-readable medium containing a program which, when executed, performs instructions associated with well planning incorporating well completion design in a collaborative environment. The instructions are configured to provide a graphical user interface (GUI), which may allow one or more users to specify one or more wellpath parameters defining a wellpath to at least one target within an earth model of at least one reservoir and to specify one or more completion parameters defining completion operations, simulate the completion operations using the earth model based on the wellpath parameters and the completion parameters to generate a set of well performance measures, and determine whether the well performance measures are within defined well performance technical limits. If the well performance measures are within the defined well performance technical limits, the instructions are configured to optimize well placement within the earth model that is stored in memory in order to maximize an objective function and if the well performance measures are not within the defined well performance technical limits, to adjust one of the wellpath parameters, the completion parameters, and any combination thereof to generate adjusted parameters and repeat the simulation operations utilizing the adjusted parameters.

One embodiment provides a system for well planning incorporating well completion design in a collaborative environment generally including a processing engine and a graphical user interface (GUI). The processing engine is configured to simulate well operations using an earth model of an earth formation including a reservoir to generate well performance measures and to determine whether the well performance measures are within well performance technical limits. The GUI is configured to specify one or more wellpath parameters defining a wellpath to at least one target within the earth model and to specify one or more completion parameters defining completion operations for use in the simulation by the processing engine and, if the processing engine determines the well performance measures are not within the well performance technical limits, allow one or more users to adjust at least one of the wellpath parameters and the completion parameters to generate adjusted parameters for use by the processing engine in repeating the simulating operations utilizing the adjusted parameters.

### BRIEF DESCRIPTION OF THE DRAWINGS

The foregoing and other aspects and advantages are better understood from the following detailed description of a preferred embodiment of the invention with reference to the drawings, in which:

FIG. 1 is a flowchart illustrating one particular embodiment for well performance modeling in a collaborative environment.

FIG. 2 is a diagram illustrating an example of a condition where an original well production metric exceeds the wells limit and a new design is implemented.

FIG. 3 is an exemplary embodiment of a collaborative environment in accordance with certain aspects of the present techniques.

FIG. 4 is an exemplary embodiment of modules in the collaborative environment in accordance with certain aspects of the present techniques.

FIG. 5 is an exemplary graphical user interface (GUI) that is used in a collaborative environment according to one embodiment of the present invention.

FIG. 6 is an exemplary GUI in which a wellpath is relocated according to one embodiment of the present invention.

FIG. 7 is an exemplary GUI that is used in a collaborative environment according to one embodiment of the present invention.

FIG. 8 illustrates an exemplary GUI in which a wellpath, in a well field, is relocated according to one embodiment of the present invention.

### DETAILED DESCRIPTION

Embodiments of the present invention may be utilized to make completion design an integral part of the well planning process by enabling the rapid evaluation of completion performance. This integration may include considering producibility (e.g. flow capacity) and operability (e.g. mechanical integrity) in well placement exercises within a collaborative environment.

The evaluation of well placement and completion design may utilize an earth model to enhance the well planning process. An earth model is a one, two, three or four dimensional representation of the subsurface area of interest, which typically is from the earth's surface to below the depth of the deepest well to be planned. The earth model is intended to represent the most comprehensive understanding of the subsurface, and may include both geologic and engineering data. Typically, it includes data relating to well bores, well logs, interpreted horizons and faults derived from wells and seismic, estimates of rock properties like temperature, pore pressure and rock strength. Another element of the earth model is what is commonly referred to as the geologic model. A geologic model is a finely scaled cellular based representation of one or more reservoirs in the subsurface, usually limited in extent to the immediate area of the reservoir. Cells within the geologic model include properties such as net to gross, rock type, porosity, permeability and saturation, which together describe the distribution of the pore space, fluid type and amounts of fluid in place. The geologic model is typically built using software designed specifically for the construction of this type of models. Further still, another element of the earth model is the reservoir simulation model, which is built to simulate the fluid flow within the reservoir and the producing facilities. The reservoir simulation model is often built on the basis of a geologic model and like the geologic model is a cellular based representation of one or more reservoirs in the subsurface. However, to facilitate the complex simulation of fluid flow through time, it typically has a slightly coarser cell structure than the geologic model. Typically, it has several properties derived from the geologic model, like porosity and permeability, but in addition it incorporates data like relative permeability, transmissibility, pore pressure, and fluid saturations that enable the simulation of fluid flow. The reservoir simulation model is typically built and executed in software specifically designed for solving the resulting 3-D finite difference, finite element, or finite volume-based equation matrices. Reservoir simulation software may be used and is known to those skilled in the art.

The earth model may be used for surveillance and optimization of the field, including management of production rates and infill drilling, to enhance the well planning process and resulting production of hydrocarbons. The incorporation of completion design into this well planning process facilitates better communication between engineers and geoscientists, both of which are associated in reservoir management teams responsible for development, production, injection, stimulation, and abandonment of producing fields.

For explanatory purposes, the following example focuses on the optimization of well placement and wellpath trajectory by a reservoir management team. It is recognized that the disclosed method and techniques are applicable to a wide variety of problems, and the following example is not intended to limit the scope of the claimed invention, but merely describe embodiments of the present techniques. Further, to facilitate understanding, examples that make reference to a single well target will be described. However, there may be multiple well targets and the techniques described herein may be applied in such cases.

Some of the operations described herein may be performed in a collaborative environment that includes a system of one or more processing devices. For instance, in some embodiments, the collaborative environment may provide a conduit for focusing discussions and interactions between team members with graphical user interfaces (GUIs). The collaborative environment may also provide interaction between remotely located users and local users via instances of the GUI. In providing this functionality, the remotely located users are able to view common data (e.g., a graphical representation of a well model and wellpaths) and, in some cases, initiate actions (e.g. adjusting parameters, displaying data, and running simulations). The collaborative environment also provides real-time sharing of data, such that if one user provides additional data to the project, it is made available to other users immediately or within a specific time period. The collaborative environment may execute on a system that may include various computer hardware components spanning the spectrum from one or more desktop computer systems to one or more large-scale visualization rooms with large-screen projection systems for visualization purposes. The collaboration environment may also include a messaging module to alert users to new data once it becomes available, activities performed by other users or analysis that either is in progress or has been completed.

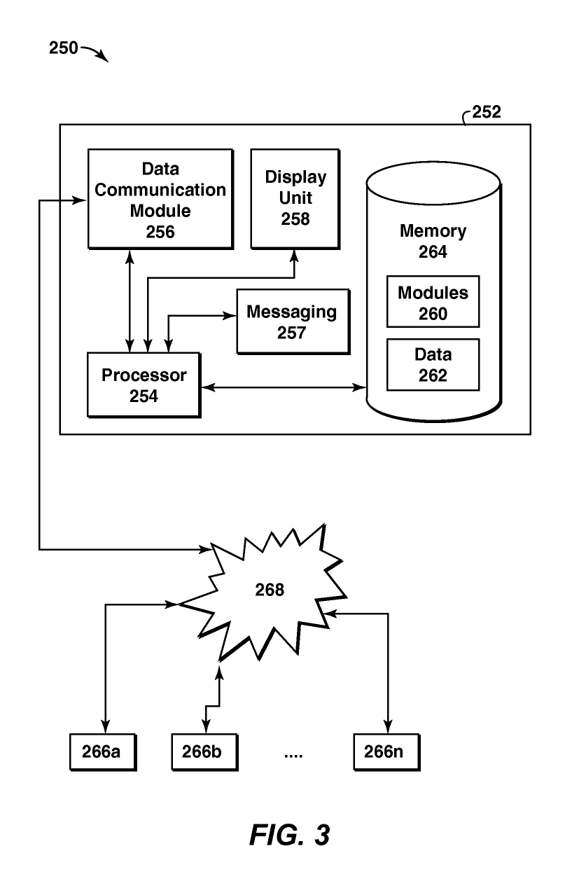

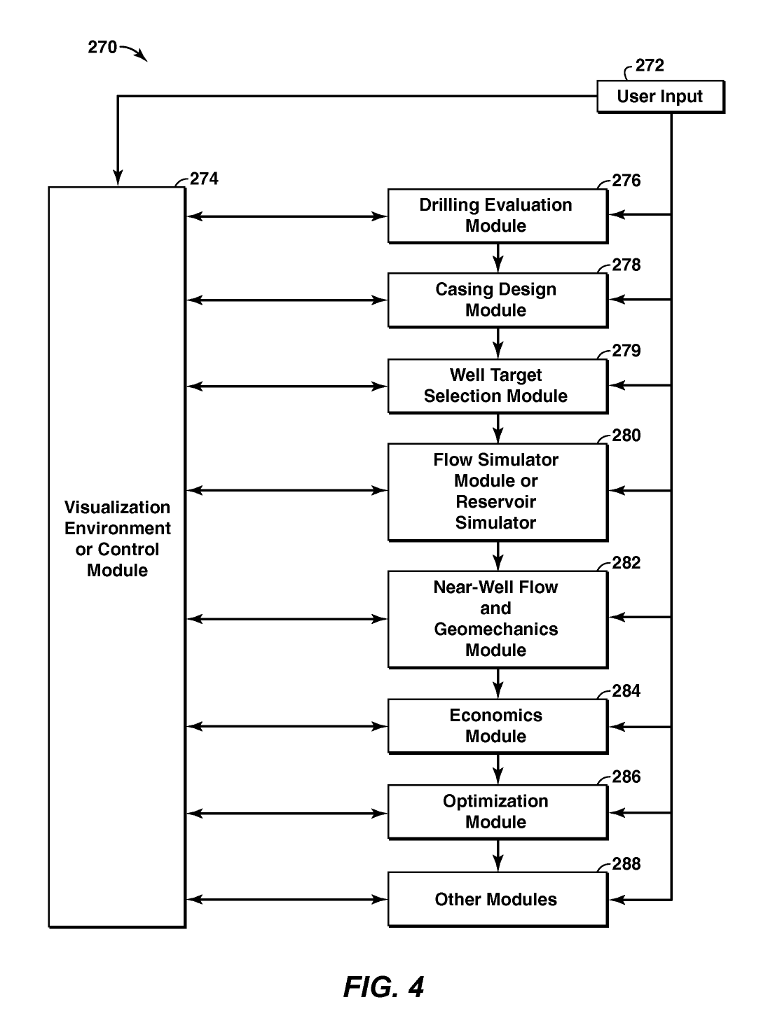

As may be appreciated, the collaborative environment may include different components to provide certain functionalities to various users. For instance, in some embodiments, the collaborative environment may include a system that includes one or more processing devices. The processing devices may include a processing engine (e.g., a processor executing instructions on a computer system or other suitable device) that executes modules automatically and/or, in some cases, in response to input from a user via a GUI or other input device. The processing device may include modules of software, routines, programs and/or computer readable sets of instructions or code to perform certain functions within the collaborative environment. Also, the system may include one or more viewers, such as 3 dimensional or 4 dimensional viewers, as part of their GUI and may include other interfaces, such as a virtual reality (VR) or other three dimensional immersive environment. One possible embodiment of the system is further described in FIGS. 3 and 4 below. However, it should be appreciated that the other embodiments may also be utilized.

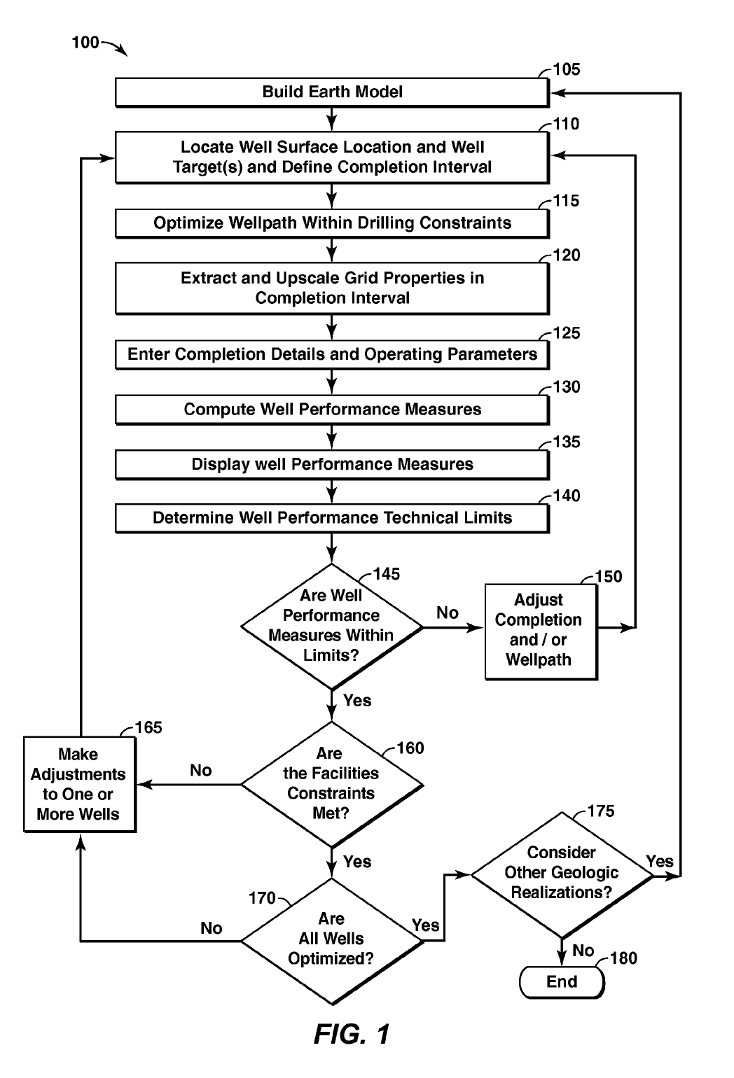

FIG. 1 is a flowchart illustrating an exemplary method 100, for a three-dimensional, collaborative, well modeling and planning environment. In this process, a surface location, one or more well targets and a set of drilling constraints may be defined to generate a well path, as described in blocks 105-115. At block 105, an earth model may be constructed in the collaborative environment. As described above, the earth model may be two-dimensional (2-D), three-dimensional (3-D), or four-dimensional (4-D). The earth model can include a geologic model that may be constructed from data gathered from a variety of sources. These sources may include seismic interpretations and data from previously drilled wells. The earth model constructed at block 105 may also include information regarding the reservoir volume, the volume between the reservoir and the surface (commonly referred to as overburden), and the volume below the reservoir (commonly referred to as underburden). Overburden may be thought of as the volume, and weight of, the overlying rock between the reservoir and the surface.

Further, the model constructed at block 105 may further provide for the association of specific physical characteristics with discrete geologic volumes. For instance, the model may be populated with facies descriptions that contain information about the overall characteristics of a portion of the subsurface (often referred to as a unit). Facies descriptions may reflect a rock unit's origin, mineralogy source, sedimentary structure, sedimentary source, fossil content and other information useful in distinguishing one facies from another. A facies description may also contain information regarding the petrophysical characteristics that control fluid behavior within the facies.

Other physical characteristics may also be contained in the model, such as pore pressure, permeability and saturation. Saturation values generally relate to the relative amount of water, oil and gas in the pores of a rock. Saturation values may be expressed as a percentage of volume. Permeability values generally express a rock's ability to transmit fluids, including liquids and/or gases, and may include absolute permeability, effective permeability and relative permeability values. Absolute permeability generally refers to the measurement of the permeability conducted when a single phase is present. Effective permeability generally refers to the ability to transmit a particular fluid through a rock when other immiscible fluids are present. Relative permeability generally refers to the ratio of effective permeability of a particular fluid, at a particular saturation, to an absolute permeability of that fluid at total saturation.

Once the model is constructed, a well target or targets and a well surface location may be located within the earth model and a completion interval defined, as shown in block 110. Well targets may be selected, for example, by a reservoir planning team, an individual user or automatically by a well target selection module. For instance, the well target selection module may analyze a variety of geologic properties using a variety of techniques, such as time-marching techniques, to determine well targets. The completion interval may be defined by the user or calculated through an automated process based on reservoir properties assigned to the well on the basis of its intersection with the earth model and the reservoir properties contained in the earth model. The completion interval may also include measured depths of the top-most penetration into the productive geologic formation and the bottom-most depth of the well.

With the well surface location, well targets, and completion interval defined, a wellpath may be optimized within drilling constraints, at block 115. Examples of drilling constraints include the depth at which the well deviates from vertical (often called kick-off depth), constraints on what sections of the well are to be straight and which should be allowed to curve and constraints on how much the curved sections are allowed to curve (commonly referred to as Dog-Leg Severity). Numerous properties sampled from the earth model may be used by a wellpath optimization module in the drilling evaluation module to automatically calculate the optimal wellpath within the drilling constraints. These properties may include pore pressure of the reservoir rock, pore pressure of the overburden rock, stress properties of the reservoir rock, stress properties of the overburden rock, and various properties of the underburden.

Calculations performed to optimize the wellpath within the drilling constraints may be performed by a wellpath optimization module in conjunction with a casing design module. The sampled properties may be used to estimate the probability of drilling success, locations of potential drilling problems and depths and properties (including weight, grade, diameter, and connection specifications) of required casing. Optimal casing and tubing design may also be calculated based on multiple load and resistance factors. Results may be retrieved (e.g., from processing engines) and displayed in the collaborative environment.

A completion design, at least to some degree, may be constrained by a corresponding casing and tubing design. Therefore, the collaborative techniques described herein may incorporate casing and tubing design. In other words, because the casing and tubing design may dictate the ranges of available parameters for completion design, it may be considered in the same collaborative workflow. Therefore, for some embodiments, casing and tubing design data (casing size, as an example), may automatically be fed to the flow simulator or completion design module of the collaborative environment, thus exerting some control on the modeled completion performance.

Casing (or tubing) design may be deterministic, probabilistic, or a combination of the two (in a hybrid design). In deterministic casing design, casing is selected so that the casing strength (or resistance) exceeds the highest anticipated load multiplied by a designated safety factor. In probabilistic casing design, the probability distribution of the casing resistance and the probability distribution of the expected loads are considered together to determine the probability of an unfavorable consequence, and the casing is selected so that the probability of the unfavorable consequence is below a designated value.

Once the well path is defined, grid properties in the completion interval may be extracted and upscaled, as shown in block 120. That is, the grid properties in the completion interval may be associated with wellpath coordinates within the defined completion interval. These grid properties may include, for example, permeability, pore pressure, saturation data, and stress data. The upscaling process may convert a fine-scale three-dimensional property map into either a more coarse-scale property map, such as a contiguous 3-dimensional reservoir model or a series of 1-dimensional streamlines, or an array of scalar properties that vary only with wellbore length associated with the wellpath. The grid properties may be upscaled in the collaborative environment (such as via geometric averaging or “time marching” (U.S. Pat. No. 6,549,879)) or using flow-based upscaling techniques in the flow simulator or flow simulation module. Some of the benefits of considering both wellpath design and completion design together in an iterative optimization scheme are illustrated in the following examples. To begin, if a horizontal well is drilled with a particular azimuth through a completion interval, it may be prone to sand production under moderate drawdown conditions because of the surrounding rock stress state. If the wellpath had been set at the time this was discovered, a more costly completion design may be required or the total production rate from the well may be limited. But by drilling the completion interval with a different azimuth, the stress state is likely to be significantly different and may allow high drawdowns with no sand production. As a second example, a flow simulator may present that a horizontally drilled well can obtain a higher production rate than a vertical well. However, the geomechanics module may reveal that the horizontal well may be prone to compaction-induced well failure under high-drawdown conditions. If these calculations were performed after well placement, as is typically done, the drawdown of the well would have to be restricted, leading to a less productive well. With the visualization environment module, the anticipated drawdown for the well may be presented as exceeding the well's compaction limits under planned operating conditions. As a result, the user (and/or the optimization module) may adjust the location of the horizontal well to reduce the surrounding stress state of the rock to a location that may not be prone to well failure. That is, restricting the well drawdown may not be required with a modified well location resulting in a more productive well.

At block 125, after grid properties are upscaled in the completion interval, completion parameters are specified for completion operations. The completion parameters may include completion details and operating parameters. Completion details may include hardware configurations, connections to the reservoir, and near-well damage, near-well stimulation, and the like. Operating parameters include targeted or allowable pressures, flow-rates, and other boundary conditions. Together these completion parameters affect the pressure-flow relationship within the wellbore and near-well region. The effect of these completion parameters is to influence the pressure-flow relationship within the wellbore and near-well region. The completion parameters may be manually entered, automatically generated by a computational algorithm, or automatically pulled from a table or three-dimensional earth model.

As shown in blocks 130-135, the well's behavior is simulated to generate a set of well performance technical limits based on the wellpath parameters and the completion parameters. For instance, at block 130, well performance measures may be computed using the flow simulator. The flow simulator may utilize rock properties, fluid properties, completion hardware dimensions, wellbore hydraulics and skin (near wellbore resistance to flow) to provide well performance measures. As an example, the flow simulator may include several factors including near-wellbore damage, geometric effects and non-Darcy flow to account for the skin effects. The flow simulator may also incorporate a full-field gridded reservoir model involving one well or multiple wells, or an analytical reservoir model incorporating scalar reservoir properties along the wellbore. The flow simulator may solve the system of equations in a short period of time so that alternatives may be explored in substantially real-time. The simulator may utilize one or more analytical models created at block 105.

At block 135, well performance measures (e.g., well and near-well pressure and flow profiles, generated by the flow simulator) may be displayed in the collaborative environment. The well performance measures may be displayed as profiles plotting along the displayed wellbore or via an embedded two-dimensional or multidimensional plot. The profiles that can be displayed as a function of well length may also include the inflow of each phase from the reservoir, cumulative flow rates within all wellbore flow paths, fluxes across completion components, pressure throughout the completion, skin, skin components, transmissibility, phase fractions and mathematical permutations of these variables. In addition, as will be described in greater detail below, various performance measures calculated by the flow simulator may be displayed in the collaborative environment.

Well performance measures or metrics may include a productivity index, total well phase rates, wellhead pressure, bottomhole pressure, completion efficiency and total skin. These measures or variables may be calculated and displayed as a pseudo-steady-state view of well. Alternatively, the measures may be displayed relative to time, which may be beneficial for certain measures, such as the evolution of skin and permeability changes resulting from the summation of producing conditions through time.

At block 140, additional calculations may be performed to determine well performance technical limits, which may include physical limits of the well. The physical limits may include production-induced compaction-related impairment or failure, sand production, near-well damage from fines migration or chemical deposition. These calculations may be performed by the flow simulator, or calculated separately by the user or automatically calculated via modules or scripts associated with or internal to the collaborative environment. It is also possible that these calculations may be performed by an externally linked module. In any case, the resulting well performance technical limits may then be displayed in the collaborative environment. The results may also be overlaid upon or compared to the well performance measures, such as pressure/flow prediction and/or the predicted wellbore inflow profile.

At block 145, a determination is made whether the well performance measures are within well performance technical limits. If the well performance measures are not within the defined well performance technical limits, adjustments may be made to the wellpath and/or completion design, as shown in block 150. These adjustments may result in one or more iterations through blocks 110-140. For example, beginning at block step 110, to again perform the modeling operations and simulations if the wellpath is adjusted. Similarly, alterations to the completion design may result in an iteration of the performance measurement operations in block 130. In either case, these operations may be iteratively performed as adjustments to the wellpath and/or completion design are made.

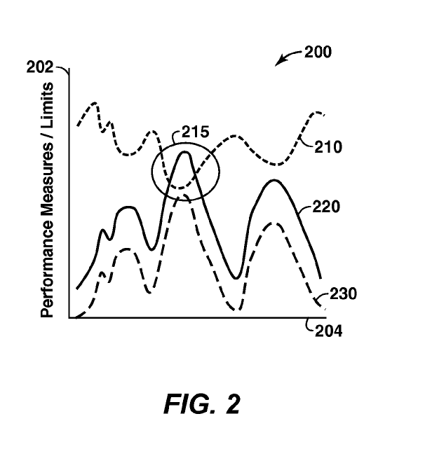

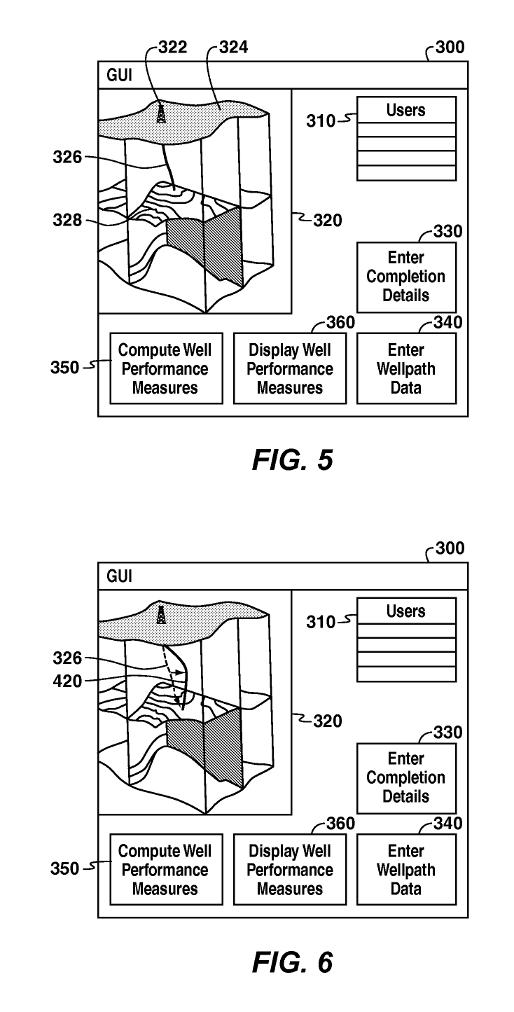

FIG. 2 is a graph 200, that illustrates the relationship between a well performance technical limit 210, an original computed well performance measure 220 and a newly computed well performance measure 230 (e.g., computed based on a new or adjusted design parameter). The y-axis 202 represents a value of a computed well performance measure or limits (e.g., in a corresponding unit) of interest, while the x-axis 204 represents depth, but may be modified to represent drawdown, depletion or time. In FIG. 2, the well performance technical limit 210 (e.g., calculated at block 140) may vary with time (for example, as production and well conditions change over time), well depth, or other measurable variables, such as reservoir drawdown or depletion. The original computed well performance measure 220 (e.g., computed for an original design under evaluation) may be periodically compared, as noted in block 145, to the well performance technical limit 210 to detect overlimit conditions. As depicted, the original computed well performance measure 220 may exceed the well performance technical limit 210 at some time, as indicated in the circled region 215. Such a condition may lead to inefficiencies and may cause damage to the well. For some embodiments, an indication may be provided that the well performance measures have exceeded the desired well performance technical limits. This indication may include displayed text, visual image, or audible sound that is provided in the collaborative environment, such as that described below with reference to FIGS. 5-8. After adjusting the well completion design and/or wellpath, a revised well performance measure 230 may be determined. As illustrated, the revised well performance measure 230 does not exceed the well performance technical limit, as determined in block 145, and may, thus, avoid the need for costly repairs and downtime.

Returning to the flow diagram of FIG. 1, after it is determined, at block 145, that the well performance measures are within the desired well performance technical limits, a variety of different actions may be taken. For some embodiments, an indication may be provided that the well performance measures are within the desired well performance technical limits. This indication may include displayed text, visual image or audio sound that is provided in the collaborative environment, such as that described below with reference to FIGS. 5-8. For some other embodiments, the overall impact on a facility (i.e., a field of multiple wells) may be considered. In this manner, the modeling of the well performance of a specific well may be automatically coupled to the modeled performance of a related set of wells (facilities network) and used as part of a field-level optimization effort.

While an individual well's performance may be optimized using the techniques discussed earlier, constraints at the field level (such as the flow capacity of the surface facilities) may not allow all of the wells in the field to achieve their optimal performance. Therefore, the constraints of the facilities should be taken into consideration when determining the optimal achievable performance of the wells. The field optimization is also dependent on the overall production of the reservoir, so that it may be optimal at a field level to operate a well below its individual optimal rate so that the economics of the entire field are maximized.

If the well performance measures are within the defined well performance technical limits 140, a determination of whether the overall field expectations are met is made (e.g., within a specific threshold). This determination may be made, for example, by comparing sums of specific well performance measures for one or more wells to specified facilities constraints 160. Some exemplary facilities constraints include well rates and surface pressure for a facilities network. If the facilities constraints have not been met (e.g. not within a threshold), adjustments may be made, at block 165, to one or more wells in the facilities network. These adjustments may include modifying one or more wells, their completion details, and/or their operating parameters. Then, the process may be repeated based on these adjustments at block 110.

The facilities constraints are based on the performance limitations of the facilities network. The facilities network ties each of the wells into a common gathering and processing system. The inputs into the facilities network include well rates and well surface pressures. The facilities network allows the user to manipulate the total field rates, pipeline and equipment pressures and individual well rates to determine how altering surface parameters affects the performance of the individual wells and the field as a whole.

If the facilities constraints are met, a determination of whether the one or more wells are optimized is made, as shown in block 170. To optimize the placement of the wells, the user may add wells or modify existing well targets, completion intervals, drilling constraints, wellpaths and completion parameters, as shown in block 165. This process may also be done by an automated optimization scheme via an optimization module in the collaborative environment. In such a scheme, multiple realizations may automatically be created and analyzed to optimize an objective function. Such an objective function is designed to determine the ability of each well (as well as the field) to achieve a set of objectives. The objective function includes a number of variables, such as probability of drilling success, well rates, recovery factors, various economic measures, and other parameters that are useful to the success of the project. Within the objective functions, each variable may be given a weighting factor which is related to the relative importance of each variable. As such, an iterative analysis may automatically be performed, for example repeating operations of the method 100 beginning at block 110.

If the one or more wells are determined to be optimal, at block 170, the same or similar design and operating optimizations may then be applied to alternate realizations of the earth model at block 175. Optimization using alternate earth model realizations may provide valuable insight, for example, in determining the effect of uncertainty on the well design, which may be taken into account in the overall optimization scheme. If additional wells are considering alternative geologic realizations, the process may be repeated at block 110. However, if no additional alternative geologic realizations are to be considered, the process may end at block 180.

To perform the optimization, a user(s) may work through a series of alternative wells by varying well targets, well drilling constraints, completion details, operating parameters and evaluating the performance measures against the technical limits to identify an optimized well. Alternatively, a user may design a range of acceptable well targets, well drilling constraints, casing design constraints, completion details, operating parameters, and/or well performance limits through the use of an optimization module. If the optimization module is included in the collaborative environment, the above ranges may be used as inputs along with data from other modules (e.g. drilling evaluation module, casing design module, etc). The optimization module may evaluate a range of possible permutations of the above mentioned ranges. Using the optimization algorithms that are part of the optimization module, this module may search for and identify the optimal well design, specified as an objective function.

In one example, the optimization module may include an objective function that has a “goodness factor.” The goodness factor may be a numerical, textual or graphical attribute that relates a value that is a result from the objective function. The goodness factor may be adjusted based on the shortest measured depth well possible that achieves a certain maximum well rate (a performance limit measure); for a given well path and a given set of operating parameters, the casing design and completion type that provides the maximum rate whilst staying within a set of performance technical limits; given a range of well targets, drilling constraints, casing constraints, completion detail constraints find the combination of these parameters that result in the highest productivity (rate as function of drawdown); using a range of the above parameters and an economics module that allows the estimate of cost of the well (as a function of the above parameters) and also a measure of the “reward” of the above well (as a function of the well performance measures), find the combination of the above parameters that results in the best economics score (net present value, return on investment, or the like). However, it should be appreciated that the objective function may include other aspects as well. The different objective functions may vary based on the specific parameters, such as well targets, well drilling constraints, completion details, while instructing the optimization module to evaluate, using other modules of the collaborative environment for calculation purposes, a large number of possible combination of parameters, and then, using optimization algorithms or search algorithms to determine the ideal combination of parameters, as measured by the objective function. Accordingly, it should be appreciated that development of other specific instances would be routine to those skilled in the art based on the teachings in this disclosure.

As an exemplary embodiment, the method described above may be implemented in a collaborative environment, such as the system 250 shown in FIG. 3. FIG. 3 is an exemplary embodiment of a system 250 having different elements and components that are utilized to model, calculate and display the results of the calculations (e.g. well performance measures, well performance technical limits, wellpath parameters, completion parameters in graphical or textual form) in the collaborative environment. The system 250 may include a computer system 252 that has one or more processor(s) 254, data communication modules 256, messaging units 257, monitor or display units 258, and one or more modules 260 (e.g. routines, applications or set of computer readable instructions) and data 262 stored in memory 264. The computer system 252 may be a conventional system that also includes a keyboard, mouse and other user interfaces for interacting with a user. The messaging unit 257 may be used to alert users to new data once it becomes available, to activities performed by others users or to analysis that either is in progress or has been completed. The modules 260 may include the code configured to perform the methods or automated calculations described above, while the data 262 may include various parameters, such as completion parameters, wellpath parameters, and/or other information utilized in the method described above. Of course, the memory 264 may be any conventional type of computer readable storage used for storing applications, which may include hard disk drives, floppy disks, CD-ROMs and other optical media, magnetic tape, and the like.

Because the computer system 252 may communicate with other devices, such as client devices 266a-266n, the data communication component 256 may be configured to interact with other devices via two way communication over a network 268. For example, the client devices 266a-266n may include computer systems or other processor based devices that exchange data, such as the well performance measures, well performance technical limits, completion parameters or wellpath parameters, for example, with computer system 252. In particular, the client devices 266a-266n may be associated with members of the reservoir management team located at different locations. As these devices may be located in different geographic locations, such as different offices, buildings, cities, or countries, a network 268 may be utilized provide the communication between different geographical locations. The network 268, which may include different network devices, such as routers, switches, bridges, for example, may include one or more local area networks, wide area networks, server area networks, metropolitan area networks, or combination of these different types of networks. The connectivity and use of the network 268 by the devices in the system 250 is understood by those skilled in the art.

To utilize the system, a user may interact with the modules 260 via graphical user interfaces (GUIs), which are described in further detail in FIGS. 5-8, and other user input devices. Via the screen views or through direct interaction, a user may launch one or more modules to perform the methods described above. As such, a user may interact with the modeling program to construct and execute the simulation of the reservoir model.

FIG. 4 is an exemplary embodiment of the modules' interaction within the collaborative environment. In this embodiment 270, modules 274-288 are examples of the modules 260 located in the memory 264 of the computer system 252 of FIG. 3. User input 272 may be provide to the modules 274-288 via a keyboard, mouse, touch pad, or other input device. The user information may be entered into the modules from input devices through interactions with the user via GUIs, which are described further in FIGS. 5-8 below. The user inputs 272 may include any parameters used in the calculations in the various modules, such as target locations, surface pressure, flow rates, completion type, casing size, drilling costs, price forecasts, and the like. In addition to the user inputs, the various modules 274-288 may communicate with each other. The modules may communicate via buses, memory accesses, through application interfaces and the like.

The modules 274-288 may be used to perform specific functions for the collaborative environment. For example, the visualization environment or control module 274 may present multiple geologic and well data sets simultaneously in a 1, 2, 3, or 4-dimensional view, as well as control data transfer between and among the other modules. The drilling evaluation module 276 may calculate the expected torque and drag for the wellpath, as well as casing set points, mud weights, potential problem spots based on the surrounding geology, and the probability of successfully drilling along the wellpath. The casing design module 278, which is described above, may determine the minimum casing weight and grade that maintains well integrity within the range of expected producing conditions. The well target selection module 279, which is described above, may determine the locations of the wells. The flow simulator module or reservoir simulator 280 may quantify the expected flow rate or wellbore pressure for each well (along each point within the completion interval as well as for the entire well), simulate the pressures, fluxes, and saturations throughout the reservoir as a function of time, and estimate recoverable reserves. The near-well flow and geomechanics module 282 may calculate the well limits as described previously, such as the maximum drawdown allowable to avoid compaction-induced well failure or the maximum rate allowable to avoid sand production, as well as calculate near-well resistance to flow (i.e., skin). The economics module 284 may calculate various economic measures based on the well design such as well cost, rate of return, and the like. The optimization module 286 may create permutations of numerous input variables from the other modules, then execute each module repeatedly to create a response surface, relating the input variables to a set of objective functions and/or find the maximum or minimum of the objective functions by executing each module repeatedly using a set of variables determined by the optimization module. The other modules 288 may perform other calculations for the control module 274 and/or operate to maintain the communication between the modules, for example.

As an example of the operation of the modules, user input 272 may be received and provided to specific modules 274-288. The control module 274 may receive this data to provide it to the respective modules 276-288 or it may be provided directly to the modules 276-288. The control module 274 may provide wellpath parameters and/or rock properties to the drilling evaluation module 276, while the drilling evaluation module 276 may provide an estimate for a chance of success or casing depths to the control module 274. The control module 274 may provide wellpath parameters and/or casing depths to the casing design module 278, while the casing design module 278 may provide casing weights, grade and pressure/stress limits to the control module 274. The control module 274 may provide geologic properties, such as porosity, permeability, and lithology to the well target selection module 279, while the well target selection module 279 may provide well targets to the control module 274. The control module 274 may provide wellpath parameters and/or reservoir properties to the flow simulator module 280, while the flow simulator module 280 may provide fluid inflow rates and/or wellbore pressures to the control module 274. The control module 274 may provide wellpath parameters, rock properties, and/or wellbore properties to the near-well flow and geomechanics module 282, while the near-well flow and geomechanics module 282 may provide production limits to the control module 274. The control module 274 may provide production rates and/or drilling and completion data to the economics module 284, while the economics module 284 may provide costs, rate of return and other financial data to the control module 274. The control module 274 may provide costs, production rates and/or success probabilities to the optimization module 286, while the optimization module 286 may provide one or more values for the objective function to the control module 274.

Regardless, the various modules 274-288 may be utilized together to enhance the efficiency and overall result of the well placement process by finding integrated solutions that are more optimal than could be achieved by performing each module once in sequence as is typically done in the industry.

An exemplary graphical user interface (GUI) 300 that may be used in a collaborative well planning environment is depicted in FIG. 5. As illustrated, the GUI 300 may contain a user screen portion 310 for displaying a list of (collaborating) users, an image screen portion 320 for displaying a three-dimensional model, a completion details control tab (e.g., button) 330 to access an interface for entering completion details, a wellpath control tab 340 to access an interface to enter wellpath data, a compute control tab 350 to initiate computation of well performance measures, and a display control tab 360 to invoke a display of well performance measures.

In one embodiment, the members of a reservoir management team (who may be listed in user screen portion 310) may be remotely located. In such cases, each member may have their own respective GUI 300 (e.g., running on their local computer). The members may be represented in a number of ways including, by their respective names, by unique identification numbers, by icons, avatars, or any other suitable means. The user screen portion 310 may indicate which members are currently active (e.g., logged on and viewing a GUI 300) or may display only active members. In any case, the GUI 300 may facilitate communication between the users. Communication may be in many forms including, text, voice and video.

For example, the image screen portion 320 may allow remotely located users to view a depiction of the same three-dimensional (3-D) model. The 3-D model may depict topographical information 324 and the location of a well surface location or drilling rig 322. For some embodiments, users may be able to make real-time adjustments to the 3-D model to view the effect on optimization by interacting with the image screen portion 320. For example, a user may be able to select the drilling rig 322 and change its position on the depicted topology 324 and/or adjust a wellpath 326 between the drilling rig 322 and a reservoir target 328.

Adjustments to a wellpath or drilling rig may be performed through a variety of mechanisms and result in automatic updating of various computed performance measurements. For instance, changing the position of the drilling rig 322 may automatically update various variables and corresponding representations. Alternately, a user may cause the 3-D model to be updated by selecting the interface to compute well performance measures (via compute control tab 350). Changes made by one user may be visible by other users in real time. Alternately, changes may not be made visible until a user activates the display well performance measures interface (via display control tab 360).

As depicted in FIG. 6, a user may be able to move the wellpath 326 from a first position shown in FIG. 5 to a second position, for example, by selecting and dragging the wellpath 326 with a mouse to create a new wellpath 420. In a similar manner, a user may change the target of the wellpath as well as the route taken to reach the target. In addition, such changes may also be accomplished by changing corresponding wellpath data (via wellpath control tab 340).

In addition, for some embodiments, the wellpath may be moved automatically under application control, for example, in response to various calculations and optimization routines. Depending on the particular environment, it may be possible to control whether changes made by one user are automatically visible by the other users in real time. It may also be possible for variables and constraints affected by moving the wellpath to the second wellpath position 420 to be automatically displayed.

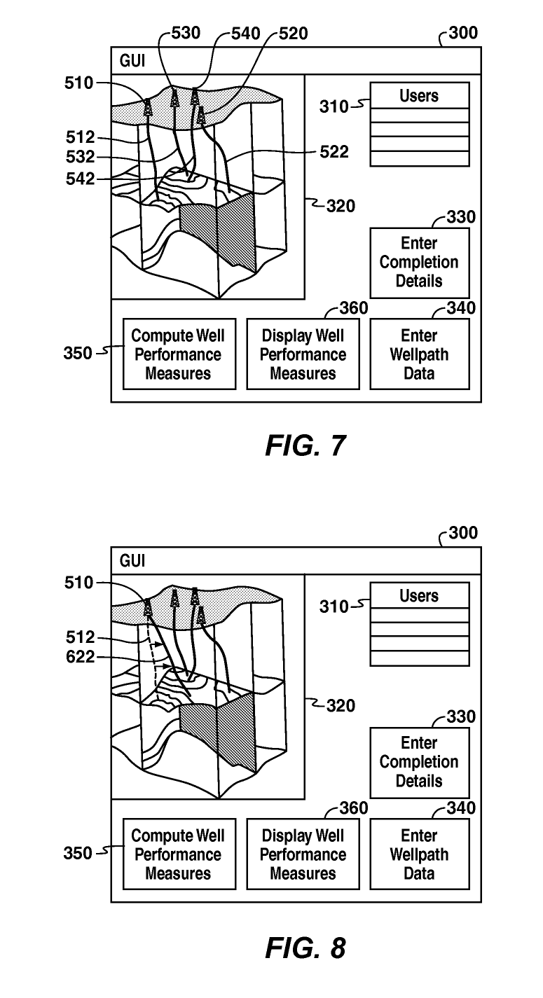

As illustrated in FIG. 7, for some embodiments, multiple drilling rigs and multiple wellpaths may be depicted in the image screen portion 320, presenting a “facility-wide” or facility network view. FIG. 7 depicts four separate drilling rigs 510, 520, 530 and 540. Also depicted, are the corresponding wellpaths 512, 522, 532 and 542. Operations described above with reference to a single wellpath may be performed to manage a field including multiple wells, which may be associated with the drilling rigs 510, 520, 530 and 540. For example, by adjusting the location of one drilling rig, the parameters of other rigs may change. The location adjustments and resulting parameter changes may be visible to all users indicated in the user screen portion 310.

As depicted in FIG. 8, it may be possible for a user to select one wellpath and move it from a first wellpath position 512 to a second wellpath position 622. As in the single wellpath application described above, a user may change the target of the wellpath as well as the route taken to reach the target. Changing one or more wellpaths may affect other wells being modeled. For some embodiments, changes resulting from moving a wellpath may be automatically calculated and displayed, or they may determined through activation of the compute control tab 350.

For some embodiments, remote users may be able to use separate programs (such as engineering applications for flow simulation and production evaluation) to perform calculations based on information provided from a visualization environment (e.g., including GUIs such as those described above). The results of their calculations may then be provided to the visualization environment (e.g., via a manual or automatic update). One advantage of this capability is that all users are not required to actually review or interact directly with the visualization GUI 300, yet their respective calculations may still effect the image screen portion 320.

For some embodiments, the techniques described herein may be applied to incorporate well completion screening and design in a collaborative environment. Such techniques may allow a user to specify one or more wellpath parameters defining a wellpath to a target (or set of targets) within a geologic model of an earth formation including a reservoir. The user may also specify one or more conditions or limits on the completion interval(s) including, but not limited to, deviation angle through the reservoir and length of well segment passing through the reservoir. The user may also specify one or more or completion parameters defining completion operations.

Interactive testing may then be performed for possible well locations within a collaborative environment, automatically testing to determine if defined conditions are satisfied (e.g., by automatically calculating the well length and deviation angle through the reservoir volume). An alarm (or other type notification) may be issued if the user defined limits are not satisfied. On the other hand, if the limits are satisfied for a particular target location, simulation operations using the model based on the wellpath and the completion parameters may be performed.

In such an embodiment, an application such as that described above may allow a user to manipulate a graphical representation of a target (e.g., using a mouse or other input device to “drag” it to locations of interest). As the user is moving the target (or after the target is “released”), the application may automatically calculate the wellpath based on the input constraints and then calculate the completion screening parameters (length of possible completion by intersecting the wellpath with the reservoir volume and determining the deviation angle through the reservoir volume).

Completion screening parameters, which are a subset of the completion parameters, may then be automatically verified against the user defined criteria (e.g. bounds on the completion screening limits). Results of this verification may be provided in a number of ways, for example, by displaying the values on the screen while the well target is being manipulated and/or sounding (and/or displaying) an alarm if the limits are not satisfied. In this manner, potential well trajectory or target options that do not meet minimum criteria can be excluded prior to proceeding to the more computationally intensive step of simulating operations. Thus, this approach of screening may result in significant reduction in computational resources.

For some embodiments, in addition to (or instead of) screening against user-specified completion zone limits/constraints, screening that accounts for cost may also be performed utilizing a cost function (e.g., one embodiment of the object function). For some embodiments, this cost function may be a relatively simple function of the length and type of completion (e.g., where user defines some simple cost relationships and the costs are calculated interactively as wellpath/target locations are attempted). For some embodiments, relatively complex cost functions may be developed where costs are estimated based, at least partially, on completion/well design parameters and then compared to well performance measures to produce a rough estimate of profitability. For some embodiments, a user may be able to choose to apply a relatively simple or more complex cost function, for example, depending on the desired result.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

What is claimed is:

1. A method for well planning incorporating well completion design in a collaborative environment, comprising:
specifying one or more wellpath parameters defining a wellpath to at least one target within an earth model stored in memory;
specifying one or more completion parameters defining a completion operation;
simulating the completion operations using the earth model based on the wellpath parameters and the completion parameters to generate a set of well performance measures;
determining whether the well performance measures are within defined well performance technical limits;
if the well performance measures are within the defined well performance technical limits, optimizing well placement within the earth model stored in memory in order to maximize an objective function; and
if the well performance measures are not within the defined well performance technical limits, adjusting one of the wellpath parameters, the completion parameters, and any combination thereof to generate adjusted parameters and repeating the simulating operations utilizing the adjusted parameters.

2. The method of claim 1, further comprising verifying facilities constraints, comprising comparing the facilities constraints to at least one of the well performance measures;
if the facilities constraints are within a threshold, optimizing well placement; and
if the facilities constraints are not within the threshold, adjusting one of the wellpath parameters, the completion parameters, and any combination thereof to generate adjusted parameters and repeating the simulating operations utilizing the adjusted parameters.

3. The method of claim 4, wherein optimizing well placement comprises varying at least one parameter, including at least the number of wells, existing well targets, well drilling constraints, completion details, wellpaths, and operating parameters to generate new well performance measures; and
evaluating the new well performance measures against the defined well performance technical limits.

4. The method of claim 1, wherein the optimization is performed by an automated optimization scheme via an optimization module in a computer system.

5. The method of claim 3, comprising repeating the method using an alternative earth model to generate alternative well performance measures.

6. The method of claim 5, wherein optimizing well placement comprises evaluating the well performance measures, the new well performance measures, and the alternative well performance measures using an objective function.

7. The method of claim 6, wherein the objective function comprises a plurality of variables and optimizes at least one of probability of drilling success, well rates, recovery factors, various economic measures, and any combination thereof.

8. The method of claim 5, wherein the optimization module utilizes ranges of wellpath parameters and completion parameters to generate alternative performance measures.

9. The method of claim 1, further comprising calculating optimal values for one or more of the completion parameters related to a casing design based on probabilistic load and resistance factors.

10. The method of claim 1, further comprising calculating optimal values for one or more of the completion parameters related to a casing design based on deterministic load and resistance factors.

11. The method of claim 1, further comprising:
applying a cost function to estimate costs based on one or more of the wellpath parameters and completion parameters.

12. The method of claim 11, wherein the cost function produces an estimate of profitability based, at least partially, on completion parameters.

13. The method of claim 1, wherein specifying the one or more wellpath parameters defining the wellpath further comprises locating a well surface location within the earth model or a target.

14. The method of claim 1, wherein simulating operations using the earth model comprises:
extracting grid properties in one or more completion intervals of the earth model based on the wellpath parameters; and
upscaling the grid properties in the one or more completion intervals.

15. The method of claim 1, further comprising:
determining whether the well performance measures associated with a group of wells are within the well performance technical limits for the group of wells;
if the well performance measures associated with the group of wells are within the well performance technical limits, providing an indication to a user; and
if the well performance measures associated with the group of wells are not within the well performance technical limits, adjusting one or both of wellpath parameters and completion parameters for one or more wells in the group of wells.

16. The method of claim 1, wherein adjusting one of the wellpath parameters, the completion parameters, and any combination thereof is performed by one of multiple users in the collaborative environment via a graphical user interface.

17. The method of claim 16, wherein a graphical user interface adjusts a wellpath by manipulating a graphical representation of the wellpath based on input from one of the group of users.

18. A computer-readable medium containing a program to perform instructions associated with well planning incorporating well completion design in a collaborative environment, the instructions configured to:
provide a graphical user interface (GUI) configured to specify one or more wellpath parameters defining a wellpath to at least one target within an earth model of at least one reservoir and to specify one or more completion parameters defining completion operations;
simulate the completion operations using the earth model based on the wellpath parameters and the completion parameters to generate a set of well performance measures;
determine whether the well performance measures are within defined well performance technical limits;
if the well performance measures are within the defined well performance technical limits, optimize well placement within the earth model that is stored in memory in order to maximize an objective function; and
if the well performance measures are not within the defined well performance technical limits, adjust one of the wellpath parameters, the completion parameters, and any combination thereof to generate adjusted parameters and repeat the simulation operations utilizing the adjusted parameters.

19. The computer-readable medium of claim 18, wherein the adjustment is performed automatically by a module of the program.

20. The computer-readable medium of claim 18, wherein the adjustment is performed based on input from one of a group of users via the GUI.

21. The computer-readable medium of claim 20, wherein multiple users at different locations can adjust one or both of the wellpath parameters and the completion parameters via an instance of the GUI.

22. The computer-readable medium of claim 21, wherein the input from the one or more users via the GUI comprises a change in the wellpath in response to manipulation of a graphical representation of the wellpath in the GUI.

23. The computer-readable medium of claim 18, wherein the GUI allows one or more of the users to specify one or more of the wellpath parameters by defining a wellpath to the at least one target within the earth model by locating a well surface location within the earth model.

24. The computer-readable medium of claim 18, wherein optimizing well placement is performed by an optimization module and comprises varying at least one parameter, including at least the number of wells, existing well targets, well drilling constraints, completion details, wellpaths, and operating parameters to generate new well performance measures; and
evaluating the new well performance measures against the defined well performance technical limits.

25. The computer-readable medium of claim 24, wherein the optimization module utilizes a range of wellpath parameters and completion parameters to generate alternative well performance measures.

26. The computer-readable medium of claim 18, wherein the instructions are configured to display a graphical representation of the generated set of well performance measures relative to the defined well performance technical limits.

27. A system for well planning incorporating well completion design in a collaborative environment comprising:
a processing engine for simulating well operations using an earth model of an earth formation including a reservoir to generate well performance measures and determine whether the well performance measures are within well performance technical limits; and
at least one graphical user interface (GUI) configured to specify one or more wellpath parameters defining a wellpath to at least one target within the earth model and to specify one or more completion parameters defining completion operations for use in the simulation by the processing engine, if the processing engine determines the well performance measures are within the well performance technical limits, provide an indication to a user, and if the processing engine determines the well performance measures are not within well performance technical limits, allow one or more users to adjust at least one of the wellpath parameters and the completion parameters to generate adjusted parameters for use by the processing engine in repeating the simulating operations utilizing the adjusted parameters.

28. The system of claim 27, wherein the processing engine resides on a first computer system and the at least one GUI resides on a second computer system.

29. The system of claim 27, wherein the at least one GUI comprises multiple instances of a GUI at different user locations.

30. The system of claim 29, wherein multiple users at different locations can adjust one or both of the wellpath parameters and the completion parameters via their corresponding instance of the GUI.

31. The system of claim 29, wherein the GUI is configured to adjust a wellpath by manipulating a graphical representation of the wellpath in the GUI based on input from one or more users.

32. The system of claim 31, wherein the processing engine automatically generates a new set of well performance measures in response to the adjusted wellpath.

33. The system of claim 29, wherein the GUI is configured to display a graphical representation of the generated set of well performance measures relative to the defined well performance technical limits.

34. The system of claim 33, wherein the GUI is configured to display a graphical representation of the generated set of well performance measures relative to the defined well performance technical limits in response to input from one of the users.
